(19) United States
(12) Patent Application Publication
(10) Pub. No.: US 2024/0047126 A1
(43) Pub. Date: Feb. 8, 2024

(54) MAGNETIC DEVICE AND POWER CONVERSION MODULE

(71) Applicant: Delta Electronics, Inc., Taoyuan City (TW)

(72) Inventors: Da Jin, Shanghai (CN); Litao Qian, Shanghai (CN); Yuanyuan Li, Shanghai (CN); Hongyu Zhai, Shanghai (CN)

(21) Appl. No.: 18/229,029

(22) Filed: Aug. 1, 2023

(30) Foreign Application Priority Data
Aug. 3, 2022 (CN) 202210927920.2

(51) Int. Cl. H01F 27/30; H01F 27/26; H01F 27/02; H01F 27/29; H02M 3/335; H02M 3/00

(52) U.S. Cl. CPC H01F 27/306; H01F 27/26; H01F 27/02; H01F 27/29; H02M 3/335; H02M 3/003

(57) ABSTRACT

A magnetic device for a power conversion module is provided. The magnetic device includes a magnetic core assembly. The magnetic core assembly includes an upper magnetic cover, a lower magnetic cover, a first magnetic leg, a second magnetic leg and a channel. The lower magnetic cover includes a first opening and a second opening. The first magnetic leg is disposed between the upper magnetic cover and the lower magnetic cover. The second magnetic leg is disposed between the upper magnetic cover and the lower magnetic cover. The channel is disposed between the first magnetic leg and the second magnetic leg. When the upper magnetic cover and the lower magnetic cover are locked on a circuit board, the first magnetic leg and the second magnetic leg are included in a projection region of the upper magnetic cover with respect to the lower magnetic cover.

### CROSS-REFERENCE TO RELATED APPLICATION

This application claims priority to China Patent Application No. 202210927920.2, filed on Aug. 3, 2022, the entire contents of which are incorporated herein by reference for all purposes.

### FIELD OF THE INVENTION

The present disclosure relates to a magnetic device and a power conversion module with the magnetic device, and more particularly to a magnetic device with a magnetic core assembly having openings and a power conversion module with the magnetic device.

### BACKGROUND OF THE INVENTION

With the advancement of Internet, cloud computing technologies, electric vehicle technologies, industrial automation technologies and associated technologies, the demands for electric power gradually increase. In other words, the demands for power sources are also increased. Consequently, the power conversion module has to be developed toward high power density and high efficiency. In order to meet the power requirements of high efficiency and high power density, the current industry practice is to increase the bus voltage in the electronic device (e.g., a power conversion module) from 12V to 48V. Consequently, the current loss on the bus and the cost of the bus are reduced.

In case that the input voltage is 48V, two approaches are used to achieve the purpose of power conversion. In accordance with the first approach, a power conversion module with two stage converters (e.g., a fixed-ratio converter and a buck converter) is employed. However, the efficiency of the power conversion module with two stage converters is low, and the applications thereof are limited.

In accordance with the second approach, a single-stage converter is used. The single-stage converter includes a half-bridge current-doubling rectifier circuit with discrete magnetic elements or a half-bridge current-doubling rectifier circuit with an integrated magnetic element. The power conversion module with the single-stage converter has higher conversion efficiency and higher power density. However, the inductance of the output inductor of the power conversion module is large, and the dynamic properties of the power conversion module are not satisfied.

Therefore, there is a need of providing an improved magnetic device and a power conversion module with the magnetic device in order to overcome the drawbacks of the conventional technologies.

### SUMMARY OF THE INVENTION

An object of the present disclosure provides a magnetic device. The magnetic device is an inductor or a combination of a transformer and an inductor.

Another object of the present disclosure provides a power conversion module with a voltage reduction function.

In accordance with an aspect of the present disclosure, a magnetic device is provided. The magnetic device includes a magnetic core assembly. The magnetic core assembly includes an upper magnetic cover, a lower magnetic cover, a first magnetic leg, a second magnetic leg and a channel. The lower magnetic cover is aligned with the upper magnetic cover. The lower magnetic cover includes a first opening and a second opening. The first opening and the second opening run through the lower magnetic cover. The first opening and the second opening are respectively located beside outer sides of the first magnetic leg and the second magnetic leg. The first magnetic leg is disposed between the upper magnetic cover and the lower magnetic cover. The second magnetic leg is disposed between the upper magnetic cover and the lower magnetic cover. The channel is disposed between the first magnetic leg and the second magnetic leg. When the upper magnetic cover and the lower magnetic cover are locked on a circuit board, the first magnetic leg and the second magnetic leg are included in a projection region of the upper magnetic cover with respect to the lower magnetic cover.

In accordance with another aspect of the present disclosure, a power conversion module is provided. The power conversion module includes a circuit board and a magnetic device. The circuit board includes a first surface, a second surface, a first connection hole and a second connection hole. The first surface and the second surface are opposed to each other. The first connection hole and the second connection hole run through the circuit board. The magnetic device includes a magnetic core assembly. The magnetic core assembly includes an upper magnetic cover, a lower magnetic cover, a first magnetic leg, a second magnetic leg and a channel. The lower magnetic cover is aligned with the upper magnetic cover. The lower magnetic cover includes a first opening and a second opening. The first opening and the second opening run through the lower magnetic cover. The first opening and the second opening are respectively located beside outer sides of the first magnetic leg and the second magnetic leg. The first magnetic leg is disposed between the upper magnetic cover and the lower magnetic cover. The second magnetic leg is disposed between the upper magnetic cover and the lower magnetic cover. The channel is disposed between the first magnetic leg and the second magnetic leg. When the upper magnetic cover and the lower magnetic cover are locked on the circuit board, the first magnetic leg and the second magnetic leg are included in a projection region of the upper magnetic cover with respect to the lower magnetic cover. The upper magnetic cover is installed on the first surface of the circuit board. The lower magnetic cover is installed on the second surface of the circuit board. The first magnetic leg is inserted in the first connection hole. The second magnetic leg is inserted in the second connection hole.

The above contents of the present disclosure will become more readily apparent to those ordinarily skilled in the art after reviewing the following detailed description and accompanying drawings, in which:

### BRIEF DESCRIPTION OF THE DRAWINGS

FIG. 1A is a schematic perspective view illustrating the structure of a power conversion module according to an embodiment of the present disclosure;

FIG. 1B is a schematic perspective view illustrating the structure of the power conversion module as shown in FIG. 1A and taken along another viewpoint;

FIG. 1C is a schematic exploded view illustrating the power conversion module as shown in FIG. 1A;

FIG. 1D is a schematic exploded view illustrating the power conversion module as shown in FIG. 1A and taken along another viewpoint;

FIG. 2 is a schematic circuit diagram illustrating the circuitry structure of the power conversion module as shown in FIG. 1A;

FIG. 3 is a schematic timing waveform diagram illustrating associated signals of the power conversion module as shown in FIG. 1A;

FIG. 4 schematically illustrates the magnetic device and the winding assemblies in the power conversion module as shown in FIG. 1A, in which the upper magnetic cover of the magnetic device is not shown; and

FIG. 5 schematically illustrates a portion of the magnetic device in the power conversion module as shown in FIG. 1A.

### DETAILED DESCRIPTION OF THE PREFERRED EMBODIMENT

The present disclosure will now be described more specifically with reference to the following embodiments. It is to be noted that the following descriptions of preferred embodiments of this invention are presented herein for purpose of illustration and description only. It is not intended to be exhaustive or to be limited to the precise form disclosed.

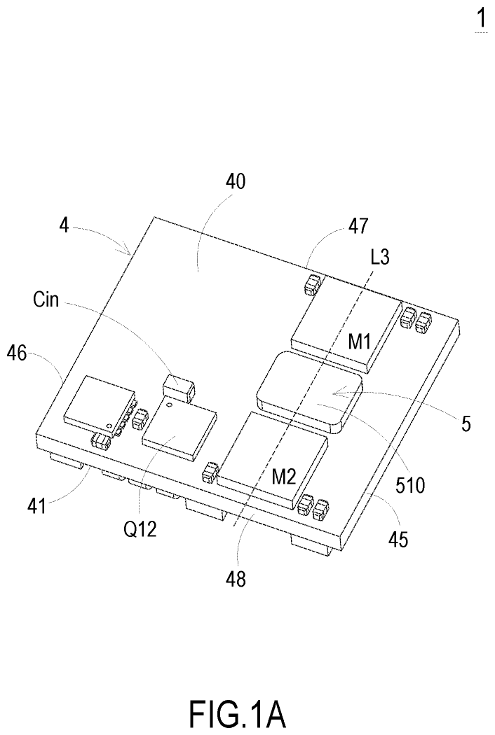

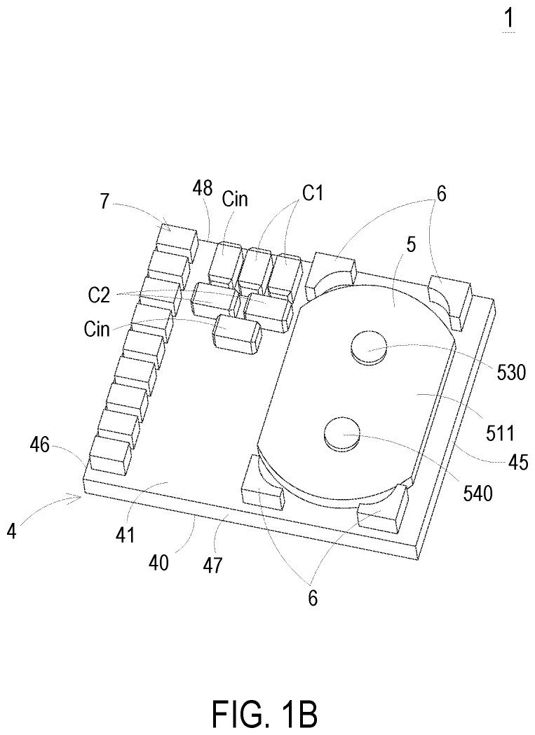

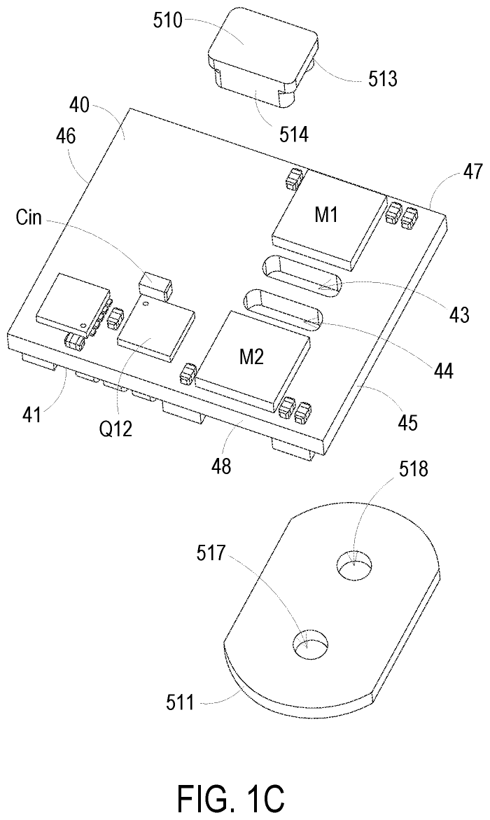

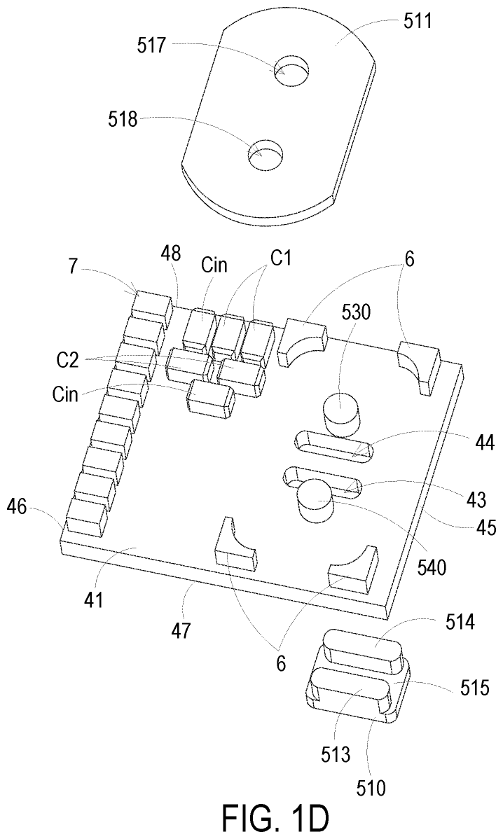

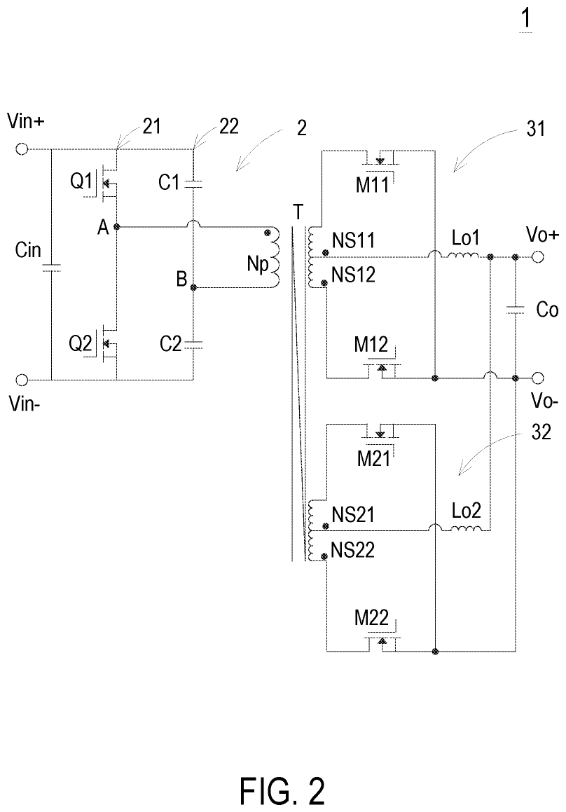

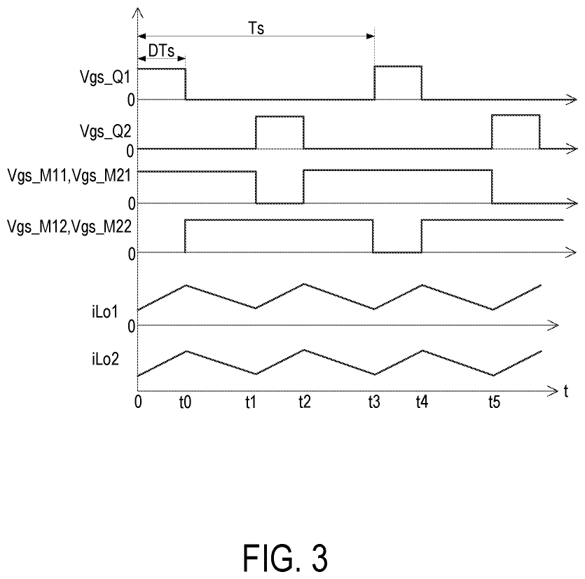

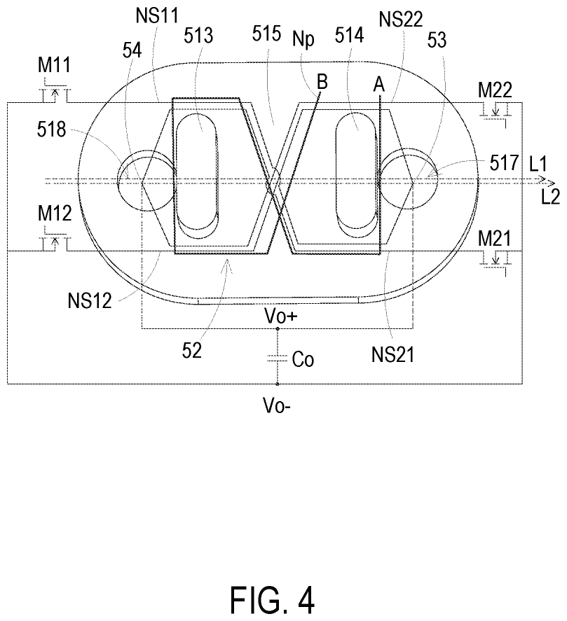

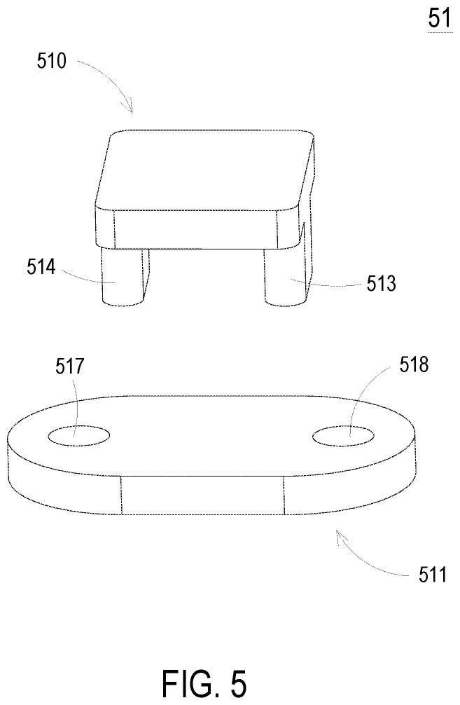

Please refer to FIGS. 1A, 1B, 1C, 1D, 2, 3 and 4. FIG. 1A is a schematic perspective view illustrating the structure of a power conversion module according to an embodiment of the present disclosure. FIG. 1B is a schematic perspective view illustrating the structure of the power conversion module as shown in FIG. 1A and taken along another viewpoint. FIG. 1C is a schematic exploded view illustrating the power conversion module as shown in FIG. 1A. FIG. 1D is a schematic exploded view illustrating the power conversion module as shown in FIG. 1A and taken along another viewpoint. FIG. 2 is a schematic circuit diagram illustrating the circuitry structure of the power conversion module as shown in FIG. 1A. FIG. 3 is a schematic timing waveform diagram illustrating associated signals of the power conversion module as shown in FIG. 1A. FIG. 4 schematically illustrates the magnetic device and the winding assemblies in the power conversion module as shown in FIG. 1A, in which the upper magnetic cover of the magnetic device is not shown. FIG. 5 schematically illustrates a portion of the magnetic device in the power conversion module as shown in FIG. 1A.

The present disclosure provides a power conversion module 1. As shown in FIG. 2, the power conversion module 1 includes an input positive terminal Vin+, an input negative terminal Vin−, an output positive terminal Vo+, an output negative terminal Vo−, a switching circuit 2, a transformer T, a first rectifying circuit 31, a second rectifying circuit 32 and an output capacitor Co. The power conversion module 1 receives an input voltage through the input positive terminal Vin+ and the input negative terminal Vin−. The output positive terminal Vo+ and the output negative terminal Vo− are electrically connected with a load (not shown). The received input voltage is converted into the output voltage by the power conversion module 1. The output voltage is provided from the power conversion module 1 to the load through the output positive terminal Vo+ and the output negative terminal Vo−. Preferably but not exclusively, the magnitude of the input voltage is greater than 40V. Preferably but not exclusively, the magnitude of the output voltage is lower than or equal to 2.2V, or even lower than or equal to 1.2V. The rated current provided from the power conversion module 1 to the load through the output positive terminal Vo+ and the output negative terminal Vo− is greater than or equal to 50 A.

The switching circuit 2 includes an input capacitor Cin, a switch bridge arm 21 and a capacitor bridge arm 22. The first terminal of the input capacitor Cin is electrically connected with the input positive terminal Vin+. The second terminal of the input capacitor Cin is electrically connected with the input negative terminal Vin−. In practice, the input capacitor Cin includes one input capacitor Cin or a plurality of input capacitors Cin. For succinctness, only one input capacitor Cin is shown in FIG. 2. The switch bridge arm 21 and the capacitor bridge arm 22 are collaboratively formed as a half-bridge circuit. The switch bridge arm 21 is electrically connected between the input positive terminal Vin+ and the input negative terminal Vin−. In addition, the switch bridge arm 21 and the input capacitor Cin are connected with each other in parallel. The switch bridge arm 21 includes an upper switch Q1 and a lower switch Q2. The upper switch Q1 and the lower switch Q2 are connected with a midpoint A of the switch bridge arm 21. The capacitor bridge arm 22 is electrically connected between the input positive terminal Vin+ and the input negative terminal Vin−. In addition, the capacitor bridge arm 22 and the input capacitor Cin are connected with each other in parallel. The capacitor bridge arm 22 includes a first capacitor C1 and a second capacitor C2. The first capacitor C1 and the second capacitor C2 are connected with each other. Moreover, the first capacitor C1 and the second capacitor C2 are connected with a midpoint B of the capacitor bridge arm 22.

The transformer T includes a primary winding NP, a first secondary winding NS11, a second secondary winding NS12, a third secondary winding NS21 and a fourth secondary winding NS22. The primary winding NP is connected between the midpoint A of the switch bridge arm 21 and the midpoint B of the capacitor bridge arm 22. That is, the first terminal of the primary winding NP is electrically connected with the midpoint A of the switch bridge arm 21, and the second terminal of the primary winding NP is connected with the midpoint B of the capacitor bridge arm 22. The first terminal of the primary winding NP is a dotted terminal. The second terminal of the primary winding NP is an undotted terminal. The primary winding NP and the switching circuit 2 are collaboratively formed as a primary circuit of the power conversion module 1. The primary winding NP is wound for N turns, wherein N is a positive integer. For example, the primary winding NP is wound for one turn.

The first secondary winding NS11 and the second secondary winding NS12 are connected with each other and collaboratively formed as a center tap structure. The first secondary winding NS11 and the second secondary winding NS12 are magnetically coupled with the primary winding NP. The second terminal of the first secondary winding NS11 and the second terminal of the second secondary winding NS12 are electrically connected with a first winding midpoint. The polarity of the second terminal of the first secondary winding NS11 and the polarity of the second terminal of the second secondary winding NS12 are opposite. The polarity of the first terminal of the first secondary winding NS11 and the polarity of the second terminal of the second secondary winding NS12 are opposite to the polarity of the first terminal (i.e., the dotted terminal) of the primary winding NP. The polarity of the second terminal of the first secondary winding NS11 and the polarity of the first terminal of the second secondary winding NS12 are identical to the polarity of the first terminal (i.e., the dotted terminal) of the primary winding NP. Moreover, each of the first secondary winding NS11 and the second secondary winding NS12 is wound for 0.5, 1 or M turns, wherein M is a positive integer. In the embodiment, each of the first secondary winding NS11 and the second secondary winding NS12 is wound for 0.5 turn.

The first rectifying circuit 31 includes a first rectifying switch M11, a second rectifying switch M12 and a first output inductor Lo1. The drain terminal of the first rectifying switch M11 is electrically connected with the first terminal of the first secondary winding NS11. The drain terminal of the second rectifying switch M12 is electrically connected with the first terminal of the second secondary winding NS12. The source terminal of the first rectifying switch M11 and the source terminal of the second rectifying switch M12 are connected with each other and electrically connected with the output negative terminal Vo−. The first output inductor Lo1 is electrically connected between the first winding midpoint and the output positive terminal Vo+. Moreover, the first secondary winding NS11, the second secondary winding NS12 and the first rectifying circuit 31 are collaboratively formed as a first secondary circuit of the power conversion module 1.

The third secondary winding NS21 and the fourth secondary winding NS22 are connected with each other and collaboratively formed as a center tap structure. The third secondary winding NS21 and the fourth secondary winding NS22 are magnetically coupled with the primary winding NP. The second terminal of the third secondary winding NS21 and the second terminal of the fourth secondary winding NS22 are electrically connected with a second winding midpoint. The polarity of the second terminal of the third secondary winding NS21 and the polarity of the second terminal of the fourth secondary winding NS22 are opposite. The polarity of the first terminal of the third secondary winding NS21 and the polarity of the second terminal of the fourth secondary winding NS22 are opposite to the polarity of the first terminal (i.e., the dotted terminal) of the primary winding NP. The polarity of the second terminal of the third secondary winding NS21 and the polarity of the first terminal of the fourth secondary winding NS22 are identical to the polarity of the first terminal (i.e., the dotted terminal) of the primary winding NP. Moreover, each of the third secondary winding NS21 and the fourth secondary winding NS22 is wound for 0.5, 1 or M turns, wherein M is a positive integer. In the embodiment, each of the third secondary winding NS21 and the fourth secondary winding NS22 is wound for 0.5 turn.

The second rectifying circuit 32 includes a third rectifying switch M21, a fourth rectifying switch M22 and a second output inductor Lo2. The drain terminal of the third rectifying switch M21 is electrically connected with the first terminal of the third secondary winding NS21. The drain terminal of the fourth rectifying switch M22 is electrically connected with the first terminal of the fourth secondary winding NS22. The source terminal of the third rectifying switch M21 and the source terminal of the fourth rectifying switch M22 are connected with each other and electrically connected with the output negative terminal Vo−. The second output inductor Lo2 is electrically connected between the second winding midpoint and the output positive terminal Vo+. The first terminal of the output capacitor Co is electrically connected with the output positive terminal Vo+. The second terminal of the output capacitor Co is electrically connected with the source terminal of the third rectifying switch M21 and the source terminal of the fourth rectifying switch M22 and electrically connected with the output negative terminal Vo− of the power conversion module 1. In addition, the third secondary winding NS21, the fourth secondary winding NS22 and the second rectifying circuit 32 are collaboratively formed as a second secondary circuit of the power conversion module 1.

In an embodiment, each of the first secondary winding NS11, the second secondary winding NS12, the third secondary winding NS21 and the fourth secondary winding NS22 includes a plurality of parallel-connected windings. In addition, each of the first rectifying switch M11, the second rectifying switch M12, the third rectifying switch M21 and the fourth rectifying switch M22 includes a plurality of parallel-connected switches.

In an embodiment, the power conversion module 1 further includes a plurality of driving circuits (not shown) and a control circuit (not shown). Preferably, the number of the driving circuits is equal to the number of the switches. For example, the power conversion module 1 includes six driving circuits. The six driving circuits are electrically connected with the upper switch Q1, the lower switch Q2, the first rectifying switch M11, the second rectifying switch M12, the third rectifying switch M21 and the fourth rectifying switch M22, respectively. The control circuit is electrically connected with the six driving circuits. The control circuit generates a plurality of PWM signals. According to each PWM signal, the driving circuit generates the corresponding driving signal to drive the corresponding switch. The on/off states of the switches are controlled according to the corresponding driving signals. Consequently, the input voltage Vin is decreased to the output voltage Vo. The operation of the power conversion module 1 will be described as follows by referring to the waveform diagram of the driving signals shown in FIG. 3.

Please refer to FIGS. 2 and 3. In FIG. 3, VGS_Q1 denotes the gate-source voltage of the upper switch Q1, VGS_Q2 denotes the gate-source voltage of the lower switch Q2, VGS_M11 denotes the gate-source voltage of the first rectifying switch M11, VGS_M12 denotes the gate-source voltage of the second rectifying switch M12, VGS_M21 denotes the gate-source voltage of the third rectifying switch M21, and VGS_M22 denotes the gate-source voltage of the fourth rectifying switch M22. Moreover, iLo1 denotes the current flowing through the first output capacitor Lo1, and iLo2 denotes the current flowing through the second output capacitor Lo2.

Please refer to FIG. 3 again. The upper switch Q1 receives a first driving signal. The waveform of the first driving signal matches the gate-source voltage VGS_Q1 of the upper switch Q1. The lower switch Q2 receives a second driving signal. The waveform of the second driving signal matches the gate-source voltage VGS_Q2 of the lower switch Q2. The duty cycle of the first driving signal and the duty cycle of the second driving signal are equal. In addition, the phase difference between the first driving signal and the second driving signal is 180 degrees.

Each of the first rectifying switch M11 and the third rectifying switch M21 receives a third driving signal. The on/off states of the first rectifying switch M11 and the on/off states of the third rectifying switch M21 are controlled according to the third driving signal. The waveform of the third driving signal matches the gate-source voltage VGS_M11 of the first rectifying switch M11 and the gate-source voltage VGS_M21 of the third rectifying switch M21.

As mentioned above, the first secondary winding NS11 is connected with the first rectifying switch M11, and the third rectifying switch M21 is connected with the third secondary winding NS21. Consequently, the frequency and the phase of the voltage across the two terminals of the first secondary winding NS11 and the frequency and the phase of the voltage across the two terminals of the third secondary winding NS21 are identical. The third driving signal and the second driving signal are complementary to each other. Each of the second rectifying switch M12 and the fourth rectifying switch M22 receives a fourth driving signal. The on/off states of the second rectifying switch M12 and the on/off states of the fourth rectifying switch M22 are controlled according to the fourth driving signal. The waveform of the fourth driving signal matches the gate-source voltage VGS_M12 of the second rectifying switch M12 and the gate-source voltage VGS_M22 of the fourth rectifying switch M22. As mentioned above, the second secondary winding NS12 is connected with the second rectifying switch M12, and the fourth rectifying switch M22 is connected with the fourth secondary winding NS22. Consequently, the frequency and the phase of the voltage across the two terminals of the second secondary winding NS12 and the frequency and the phase of the terminal voltage across the two terminals of the fourth secondary winding NS22 are identical. The fourth driving signal and the first driving signal are complementary to each other.

The switching frequency of the first driving signal for driving the upper switch Q1 is fsw, the switching frequency of the second driving signal for driving the lower switch Q2 is fsw, the duty cycle of the first driving signal is D, and the duty cycle of the second driving signal is D. Ts is the switching period, and DTs is the conducting time of the upper switch Q1 or the lower switch Q2.

According to the above control mechanism, the voltage VAB between the midpoint A of the switch bridge arm 21 and the midpoint B of the capacitor bridge arm 22 is a three-level AC voltage. That is, the voltage VAB has three voltage levels, including +Vin/2, 0 and −Vin/2. The first output capacitor Lo1 and the output capacitor Co are collaboratively formed as a first output filtering circuit. The first output filtering circuit receives an AC voltage signal. The switching frequency of the AC voltage signal is 2×fw, the duty cycle of the AC voltage signal is 2×D, and the amplitude of the AC voltage signal is Vin/(2×K) and 0. K is the result of the turn number of the primary winding NP divided by the turn number of the first secondary winding NS11. For example, if the turn number of the first secondary winding NS11 is 1, K is equal to the turn number of the primary winding NP.

As mentioned above, the switching frequency of each of the first driving signal and the second driving signal for driving each of the upper switch Q1 and the lower switch Q2 is fsw, and the switching frequency of the AC voltage signal received by the first output filtering circuit of the first output capacitor Lo1 and the output capacitor Co is 2×fw. The duty cycle of each of the first driving signal and the second driving signal is D, and the duty cycle of the AC voltage signal received by the first output filtering circuit is 2×D. Consequently, the volt-second product withstood by the first output inductor Lo1 is largely reduced. Moreover, the inductor with a smaller inductance can be used as the first output inductor Lo1 to suppress the current ripple.

Similarly, the switching frequency of each of the first driving signal and the second driving signal for driving each of the upper switch Q1 and the lower switch Q2 is fsw, and the switching frequency of the AC voltage signal received by a second output filtering circuit of the second output capacitor Lo2 and the output capacitor Co is 2×fw. The duty cycle of each of the first driving signal and the second driving signal is D, and the duty cycle of the AC voltage signal received by the second output filtering circuit is 2×D. Consequently, the volt-second product withstood by the second output inductor Lo2 is largely reduced. Moreover, the inductor with a smaller inductance can be used as the second output inductor Lo2 to suppress the current ripple.

From the above descriptions, the load dynamic response speed of the power conversion module 1 is enhanced. In addition, the technology of the present disclosure can be applied to the power conversion module with the higher input voltage and the lower output voltage. For example, the magnitude of the input voltage is greater than 40V, and the magnitude of the output voltage is lower than or equal to 2.2V (or 1.2V).

As shown in FIG. 2, the input terminal of the first secondary rectifying circuit and the input terminal of the second secondary rectifying circuit are magnetically coupled with the magnetic device of the transformer T. The detailed structure of the magnetic device will be described as follows. The output terminal of the first secondary rectifying circuit and the output terminal of the second secondary rectifying circuit are connected with the output positive terminal Vo+. Consequently, the first rectifying circuit 31 and the second rectifying circuit 32 are connected with each other in parallel. That is, the serially-connected structure of the first rectifying switch M11 and the first output inductor Lo1 and the serially-connected structure of the second rectifying switch M21 and the second output inductor Lo2 are connected with each other in parallel, and the serially-connected structure of the second rectifying switch M12 and the first output inductor Lo1 and the serially-connected structure of the fourth rectifying switch M22 and the second output inductor Lo2 are connected with each other in parallel. Since the parasitic resistance in the rectifying circuits of the power conversion module 1 is largely reduced, the conversion efficiency of the power conversion module 1 is enhanced.

In a variant embodiment, the capacitor bridge arm 22 is replaced by a second switch bridge arm, and the first capacitor C1 and the second capacitor C2 are respectively replaced by a second upper switch and a second lower switch. The second switch bridge arm is electrically connected between the input positive terminal Vin+ and the input negative terminal Vin−. The second switch bridge arm and the input capacitor Cin are connected with each other in parallel. The second upper switch and the second lower switch are connected with a midpoint of the second switch bridge arm. In other words, the switching circuit 2 includes two switch bridge arms. The methods for driving the switches of the two switch bridge arms are not restricted as long as the voltage VAB has three voltage levels including +Vin/2, 0 and −Vin/2.

In another embodiment, a blocking capacitor is disposed between the midpoint A of the switch bridge arm and the midpoint B of the capacitor bridge arm, or a current-sharing function is provided. Consequently, the DC current will not flow through the region between the midpoint A of the switch bridge arm and the midpoint B of the capacitor bridge arm.

Please refer to FIGS. 1A, 1B, 1C, 1D, 2, 4 and 5. The structure of the power conversion module 1 will be described as follows. The power conversion module 1 is installed on a system board (not shown). The power conversion module 1 includes a circuit board 4, a magnetic device 5, a plurality of rectifying switches (i.e., the first rectifying switch M11, the second rectifying switch M12, the third rectifying switch M21 and the fourth rectifying switch M22), a plurality of input capacitors Cin, the first capacitor C1, the second capacitor C2, the upper switch Q1 and the lower switch Q2. The position of the output capacitor Co is not shown in FIGS. 1A, 1B, 1C and 1D. However, the output capacitor Co can be installed on any position of the circuit board 4 or any position of the system board.

The circuit board 4 includes a first surface 40 and a second surface 41, which are opposed to each other. In addition, the circuit board 4 includes a first lateral wall 45, a second lateral wall 46, a third lateral wall 47 and a fourth lateral wall 48. The first lateral wall 45, the second lateral wall 46, the third lateral wall 47 and the fourth lateral wall 48 are disposed between the first surface 40 and the second surface 41 of the circuit board 4. The first lateral wall 45 and the second lateral wall 46 are opposed to each other. The third lateral wall 47 and the fourth lateral wall 48 are opposed to each other.

The magnetic device 5 includes a magnetic core assembly 51. A first side of the magnetic core assembly 51 is aligned with the third lateral wall 47 of the circuit board 4. A second side of the magnetic core assembly 51 is aligned with the fourth lateral wall 48 of the circuit board 4.

Please refer to FIGS. 1A, 1B, 1C, 1D, 2 and 4 again. The magnetic device 5 is formed as the transformer T. The magnetic device 5 includes the magnetic core assembly 51, a first winding assembly 52, a second winding assembly 53 and a third winding assembly 54.

The magnetic core assembly 51 includes an upper magnetic cover 510, a lower magnetic cover 511, a first magnetic leg 513, a second magnetic leg 514 and a channel 515.

The upper magnetic cover 510 and the lower magnetic cover 511 are aligned with each other. In addition, the upper magnetic cover 510 and the lower magnetic cover 511 are respectively installed on the first surface 40 and the second surface 41 of the circuit board 4. The area of the upper magnetic cover 510 is smaller than the area of the lower magnetic cover 511. For example, the area of the upper magnetic cover 510 is smaller than or equal to 80% of the area of the lower magnetic cover 511. Preferably, the area of the upper magnetic cover 510 is smaller than or equal to 70% of the area of the lower magnetic cover 511. When the upper magnetic cover 510 and the lower magnetic cover 511 are installed on the circuit board 4, at least partial projection region of the upper magnetic cover 510 with respect to any reference plane (e.g., the first surface 40 of the circuit board 4) is included in the projection region of the lower magnetic cover 511 with respect to the reference plane. However, the first magnetic leg 513 and the second magnetic leg 514 are included in the projection region of the upper magnetic cover 510 with respect to the lower magnetic cover 511.

The first magnetic leg 513 and the second magnetic leg 514 are disposed between the upper magnetic cover 510 and the lower magnetic cover 511. The channel 515 is disposed between the first magnetic leg 513 and the second magnetic leg 514. In the embodiment of FIG. 1D, the first magnetic leg 513 and the second magnetic leg 514 are integral leg structures that are connected with the upper magnetic cover 510. It is noted that numerous modifications and alterations may be made while retaining the teachings of the invention. For example, in another embodiment, the first magnetic leg 513 and the second magnetic leg 514 are integral leg structures that are connected with the lower magnetic cover 511. In another embodiment, each of the first magnetic leg 513 and the second magnetic leg 514 includes two sub-legs. One sub-leg of the first magnetic leg 513 is connected with the upper magnetic cover 510. The other sub-leg of the first magnetic leg 513 is connected with the lower magnetic cover 511. One sub-leg of the second magnetic leg 514 is connected with the upper magnetic cover 510. The other sub-leg of the second magnetic leg 514 is connected with the lower magnetic cover 511. In some other embodiments, the first magnetic leg 513 and the second magnetic leg 514 are individual leg structures. After the magnetic device 5 is assembled, the first magnetic leg 513 and the second magnetic leg 514 are disposed between the upper magnetic cover 510 and the lower magnetic cover 511.

In an embodiment, the lower magnetic cover 511 further includes a first opening 517 and a second opening 518. The first opening 517 and the second opening 518 are located beside the outer sides of the first magnetic leg 513 and the second magnetic leg 514, respectively. In addition, the first opening 517 and the second opening 518 are symmetric with respect to the center line of the first magnetic leg 513 and the second magnetic leg 514. The first opening 517 is located near the fourth lateral wall 48 of the circuit board 4. The second opening 518 is located near the third lateral wall 47 of the circuit board 4. The first opening 517 and the second opening 518 run through the lower magnetic cover 511. Preferably, the upper magnetic cover 510 is disposed between the first opening 517 and the second opening 518. In addition, the area of the upper magnetic cover 510 is smaller than the area of the lower magnetic cover 511.

Please to FIG. 4 again. A first virtual line L1 passes through the center of the first magnetic leg 513 and the center of the second magnetic leg 514. A second virtual line L2 passes through the center of the first opening 517 and the center of the second opening 518. An angle θ between the first virtual line L1 and the second virtual line L2 is greater than or equal to 0 degree and smaller than or equal to 45 degrees. For example, in the embodiment of FIG. 4, the angle θ between the first virtual line L1 and the second virtual line L2 is 0 degree. The distance between the inner surface of the first opening 517 and the neighboring edge of the lower magnetic cover 511 (i.e., the edge of the lower magnetic cover 511 at the second side of the magnetic core assembly 51) along the second virtual line L2 and the distance between the inner surface of the second opening 518 and the neighboring edge of the lower magnetic cover 511 (i.e., the edge of the lower magnetic cover 511 at the first side of the magnetic core assembly 51) along the second virtual line L2 are equal. After the upper magnetic cover 510 and the lower magnetic cover 511 are locked on each other, the distance between the center of the first opening 517 and the center of the first magnetic leg 513 and the distance between the center of the second opening 518 and the center of the second magnetic leg 514 are equal. In each of the above distances, the relative error is smaller than 40%. Since the associated distances are specially designed, the magnetic fluxes on the lower magnetic cover 511 are distributed more uniformly.

In an embodiment, the upper magnetic cover 510 has a rectangular profile, and the lower magnetic cover 511 has a runway-shaped profile. Moreover, the first magnetic leg 513 and the second magnetic leg 514 has rectangular structures, and the first opening 517 and the second opening 518 are circular openings. It is noted that the shapes of these components are not restricted. That is, the shapes of these components may be varied according to the practical requirements.

The method of winding the first winding assembly 52, the second winding assembly 53 and the third winding assembly 54 around the magnetic core assembly 51 will be described with reference to FIG. 4. For succinctness, the upper magnetic cover 510 of the magnetic core assembly 51 is not shown in FIG. 4. That is, only the lower magnetic cover 511 of the magnetic core assembly 51 is shown in FIG. 4. In FIG. 4, the positions of the first rectifying switch M11, the second rectifying switch M12, the third rectifying switch M21, the fourth rectifying switch M22 and the output capacitor Co relative to the magnetic core assembly 51 are also shown. The first rectifying switch M11 and the second rectifying switch M12 are located beside the first side of the magnetic core assembly 51 (i.e., the side near the second opening 518). The third rectifying switch M21 and the fourth rectifying switch M22 are located beside the second side of the magnetic core assembly 51 (i.e., the side near the first opening 517). The first side of the magnetic core assembly 51 and the second side of the magnetic core assembly 51 are opposed to each other. The first rectifying switch M11 and the third rectifying switch M21 are disposed along a first diagonal line. The second rectifying switch M12 and the fourth rectifying switch M22 are disposed along a second diagonal line. The first diagonal line and the second diagonal line intersect each other. In FIG. 4, the positions of the first rectifying switch M11, the second rectifying switch M12, the third rectifying switch M21, the fourth rectifying switch M22 and the output capacitor Co relative to the magnetic core assembly 51 are described for illustration. In other words, the distance between each of the first rectifying switch M11, the second rectifying switch M12, the third rectifying switch M21, the fourth rectifying switch M22 and the output capacitor Co and the magnetic core assembly 51 is not restricted to the distance shown in FIG. 4.

The first winding assembly 52 includes the primary winding NP and four secondary windings. The first terminal of the primary winding NP is located beside the second side of the magnetic core assembly 51. In addition, the first terminal of the primary winding NP is electrically connected with the midpoint A of the switch bridge arm shown in FIG. 2. The second terminal of the primary winding NP is also located beside the second side of the magnetic core assembly 51. In addition, the second terminal of the primary winding NP is electrically connected with the midpoint B of the capacitor bridge arm as shown in FIG. 2. The channel 515 is divided into a first part and a second part. The first part of the channel 515 is close to the midpoint A of the switch bridge arm. The second part of the channel 515 is away from the midpoint A of the switch bridge arm. From the first terminal to the second terminal, the primary winding NP is sequentially transferred through the second side of the magnetic core assembly 51, the second part of the channel 515, the first part of the channel 515, the first side of the magnetic core assembly 51, the second part of the channel 515, the first part of the channel 515 and the second side of the magnetic core assembly 51. That is, from the first terminal to the second terminal, the primary winding NP is wound around the second magnetic leg 514 of the magnetic core assembly 51 along a first direction (e.g., a clockwise direction) and wound around the first magnetic leg 513 of the magnetic core assembly 51 along a second direction (e.g., a counterclockwise direction). Moreover, the primary winding NP is wound for one turn.

It is noted that the method of winding the primary winding NP is not restricted. For example, in another embodiment, the primary winding NP is wound around the second magnetic leg 514 of the magnetic core assembly 51 along the second direction (e.g., a counterclockwise direction) and wound around the first magnetic leg 513 of the magnetic core assembly 51 along the first direction (e.g., a clockwise direction).

The four secondary windings of the first winding assembly 52 includes the first secondary winding NS11, the second secondary winding NS12, the third secondary winding NS21 and the fourth secondary winding NS22.

The first terminal of the first secondary winding NS11 is located beside the first side of the magnetic core assembly 51. In addition, the first terminal of the first secondary winding NS11 is electrically connected with the drain terminal of the first rectifying switch M11. The second terminal of the first secondary winding NS11 is located beside the second side of the magnetic core assembly 51. From the first terminal to the second terminal, the first secondary winding NS11 is sequentially transferred through the first side of the magnetic core assembly 51, the first part of the channel 515, the second part of the channel 515 and the second side of the magnetic core assembly 51.

The first terminal of the second secondary winding NS12 is located beside the first side of the magnetic core assembly 51. In addition, the first terminal of the second secondary winding NS12 is electrically connected with the drain terminal of the second rectifying switch M12. The second terminal of the second secondary winding NS12 is located beside the second side of the magnetic core assembly 51. In addition, the second terminal of the second secondary winding NS12 is electrically connected with the second terminal of the first secondary winding NS11. From the first terminal to the second terminal, the second secondary winding NS12 is sequentially transferred through the first side of the magnetic core assembly 51, the second part of the channel 515, the first part of the channel 515 and the second side of the magnetic core assembly 51.

As mentioned above, the first secondary winding NS11 and the second secondary winding NS12 are connected with each other and collaboratively formed as a first secondary winding assembly. From the first terminal to the second terminal, the first secondary winding NS11 is wound around the first magnetic leg 513 of the magnetic core assembly 51 along the first direction and then wound around the second magnetic leg 514 along the second direction. From the first terminal to the second terminal, the second secondary winding NS12 is wound around the first magnetic leg 513 of the magnetic core assembly 51 along the second direction and then wound around the second magnetic leg 514 along the first direction. The first direction and the second direction are opposite. For example, the first direction is the clockwise direction, and the second direction is the counterclockwise direction. Moreover, each of the first secondary winding NS11 and the second secondary winding NS12 is wound for 0.5 turn.

The first terminal of the third secondary winding NS21 is located beside the second side of the magnetic core assembly 51. In addition, the first terminal of the third secondary winding NS21 is electrically connected with the drain terminal of the third rectifying switch M21. The second terminal of the third secondary winding NS21 is located beside the first side of the magnetic core assembly 51. From the first terminal to the second terminal, the third secondary winding NS21 is sequentially transferred through the second side of the magnetic core assembly 51, the second part of the channel 515, the first part of the channel 515 and the first side of the magnetic core assembly 51.

The first terminal of the fourth secondary winding NS22 is located beside the second side of the magnetic core assembly 51. In addition, the first terminal of the fourth secondary winding NS22 is electrically connected with the drain terminal of the fourth rectifying switch M22. The second terminal of the fourth secondary winding NS22 is located beside the first side of the magnetic core assembly 51. In addition, the second terminal of the fourth secondary winding NS22 is electrically connected with the second terminal of the third secondary winding NS21. From the first terminal to the second terminal, the fourth secondary winding NS22 is sequentially transferred through the second side of the magnetic core assembly 51, the first part of the channel 515, the second part of the channel 515 and the first side of the magnetic core assembly 51.

As mentioned above, the third secondary winding NS21 and the fourth secondary winding NS22 are connected with each other and collaboratively formed as a second secondary winding assembly. From the first terminal to the second terminal, the third secondary winding NS21 is wound around the second magnetic leg 514 of the magnetic core assembly 51 along the first direction and wound around the first magnetic leg 513 along the second direction. From the first terminal to the second terminal, the fourth secondary winding NS22 is wound around the second magnetic leg 514 of the magnetic core assembly 51 along the second direction and wound around the first magnetic leg 513 along the first direction. Moreover, each of the third secondary winding NS21 and the fourth secondary winding N22 is wound for 0.5 turn.

The first terminal of the second winding assembly 53 is electrically connected with a midpoint of the first secondary winding assembly (i.e., the first winding midpoint between the first secondary winding NS11 and the second secondary winding NS12). The second terminal of the second winding assembly 53 is penetrated through the first opening 517 and electrically connected with the output positive terminal Vo+ shown in FIG. 2. That is, a portion or the entire of the second winding assembly 53 is disposed within the first opening 517. The second winding assembly 53 and the magnetic core assembly 51 are collaboratively formed as the first output inductor Lo1 shown in FIG. 2.

The first terminal of the third winding assembly 54 is electrically connected with a midpoint of the second secondary winding assembly (i.e., the second winding midpoint between the third secondary winding NS21 and the fourth secondary winding NS22). The second terminal of the third winding assembly 54 is penetrated through the second opening 518 and electrically connected with the output positive terminal Vo+ shown in FIG. 2. That is, a portion or the entire of the third winding assembly 54 is disposed within the second opening 518. The third winding assembly 54 and the magnetic core assembly 51 are collaboratively formed as the second output inductor Lo2 shown in FIG. 2.

In some embodiments, the first winding assembly 52 is disposed within the circuit board 4, and the first winding assembly 52 is a conductor within the circuit board 4. The second winding assembly 53 and the third winding assembly 54 are also conductors. For example, each of the second winding assembly 53 and the third winding assembly 54 is a copper post.

As mentioned above, the methods of winding the primary winding NP, the first secondary winding NS11, the second secondary winding NS12, the third secondary winding NS21 and the fourth secondary winding NS22 of the first winding assembly 52 are specially designed. In addition, each of the first secondary winding NS11, the second secondary winding NS12, the third secondary winding NS21 and the fourth secondary winding NS22 is wound for 0.5 turn. In other words, the first secondary winding NS11, the second secondary winding NS12, the third secondary winding NS21 and the fourth secondary winding NS22 are not very long. Since the parasitic resistance between the primary winding NP and the secondary windings is reduced, the DC loss in the region between the primary winding NP and the secondary windings is reduced.

As shown in FIG. 4, the primary winding NP, the first secondary winding assembly (i.e., the first secondary winding NS11 and the second secondary winding NS12) and the second secondary winding assembly (i.e., the third secondary winding NS21 and the fourth secondary winding NS22) are installed on different trace layers of the circuit board 4. In an embodiment, the primary winding NP has a first projection region on the first surface 40 of the circuit board 4, the first secondary winding assembly has a second projection region on the first surface 40 of the circuit board 4, and the second secondary winding assembly has a third projection region on the first surface 40 of the circuit board 4. The area of the overlap region between the first projection region and the second projection region is greater than 50% of the area of the first projection region and/or greater than 50% of the area of the second projection region. Similarly, the area of the overlap region between the first projection region and the third projection region is greater than 50% of the area of the first projection region and/or greater than 50% of the area of the third projection region.

In an embodiment, each of the first secondary winding assembly and the second secondary winding assembly is implemented with a plurality of parallel-connected trace layers in the circuit board 4. At least one of the plurality of trace layers of the second secondary winding assembly is disposed between at least two of the plurality of trace layers of the first secondary winding assembly. In addition, the trace layer of the primary winding NP is disposed between any two trace layers of the first secondary winding assembly and the second secondary winding assembly. In other words, the primary winding NP, the first secondary winding NS11, the second secondary winding NS12, the third secondary winding NS21 and the fourth secondary winding NS22 are disposed in a staggered form. Consequently, the AC loss between the primary winding NP and the secondary windings will be further reduced.

As mentioned above, the first output inductor Lo1 of the first rectifying circuit 31 is defined by the second winding assembly 53 and the magnetic core assembly 51 collaboratively. The second winding assembly 53 is electrically connected with the midpoint of the first secondary winding assembly and penetrated through the first opening 517. In other words, the length of the winding of the first output inductor Lo1 is the shortest, and the distance between the midpoint of the first secondary winding assembly and the output positive terminal Vo+ is the shortest. Consequently, the parasitic resistance and the power loss of the first output inductor Lo1 are reduced.

Similarly, the second output inductor Lo2 of the second rectifying circuit 32 is defined by the third winding assembly 54 and the magnetic core assembly 51 collaboratively. The third winding assembly 54 is electrically connected with the midpoint of the second secondary winding assembly and penetrated through the second opening 518. In other words, the length of the winding of the second output inductor Lo2 is the shortest, and the distance between the midpoint of the second secondary winding assembly and the output positive terminal Vo+ is the shortest. Consequently, the parasitic resistance and the power loss of the second output inductor Lo2 are reduced.

As mentioned above, the rectifying switches M11 and M12 of the first rectifying circuit 31 and the rectifying switches M21 and M22 of the second rectifying circuit 32 are located at two opposite sides of the magnetic core assembly 51. Since the spaces at the two sides of the magnetic core assembly 51 are effectively utilized, the parasitic resistance and the conduction loss of the rectifying switches are reduced.

As mentioned above, the first output inductor Lo1 of the first rectifying circuit 31 and the second output inductor Lo2 of the second rectifying circuit 32 are located beside two opposite sides of the magnetic core assembly 51. Since the spaces at the two sides of the magnetic core assembly 51 are effectively utilized, the parasitic resistance and the power loss of the first output inductor Lo1 and the second output inductor Lo2 are reduced.

Please refer to FIG. 3 again. In the time interval between the t=0 and t0, the upper switch Q1 of the switch bridge arm 21, the first rectifying switch M11 and the third rectifying switch M21 are in the on state. In the time interval between the t1 and t2, the lower switch Q2 of the switch bridge arm 21, the second rectifying switch M12 and the fourth rectifying switch M22 are in the on state. The primary winding NP, the first secondary winding NS11 and the fourth secondary winding NS22 are disposed within the circuit board 4 in a staggered form. The primary winding NP, the second secondary winding NS12 and the third secondary winding NS21 are disposed within the circuit board 4 in a staggered form. Consequently, the AC loss of the windings NP, NS11, NS12, NS21 and NS22 will be reduced.

In an embodiment, the upper magnetic cover 510, the first magnetic leg 513 and the second magnetic leg 514 are made of a high magnetic permeability material such as ferrite. Consequently, the magnetic loss is reduced, and the magnetic inductance is increased. The lower magnetic cover 511 is a made of a low magnetic permeability material such as iron power or magnetic power with an air gap. Consequently, the saturation current can be increased.

In an embodiment, the second winding assembly 53 is implemented with a single copper post. The first end of the copper post of the second winding assembly 53 is electrically connected with the second terminal of the first secondary winding NS11 and the second terminal of the second secondary winding NS12. Consequently, the first terminal of the second winding assembly 53 is electrically connected with the midpoint of the first secondary winding assembly. In addition, a portion or the entire of the copper post of the second winding assembly 53 is penetrated through the first opening 517. Consequently, the second end of the copper post of the second winding assembly 53 is electrically connected with the output positive terminal Vo+ shown in FIG. 2.

In another embodiment, the second winding assembly 53 is implemented with a first copper post and a second copper post. The first end of the first copper post of the second winding assembly 53 is electrically connected with the second terminal of the first secondary winding NS11. The first end of the second copper post of the second winding assembly 53 is electrically connected with the second terminal of the second secondary winding NS12. In addition, a portion or the entire of the first copper post and a portion or the entire of the second copper post are penetrated through the first opening 517. The second end of the first copper post and the second end of the second copper post are directly connected with each other and electrically connected with the output positive terminal Vo+. Consequently, the first terminal of the second winding assembly 53 is electrically connected with the first secondary winding assembly.

In an embodiment, the third winding assembly 54 is implemented with a single copper post. The first end of the copper post of the third winding assembly 54 is electrically connected with the second terminal of the third secondary winding NS21 and the second terminal of the fourth secondary winding NS22. Consequently, the first terminal of the third winding assembly 54 is electrically connected with the midpoint of the second secondary winding assembly. In addition, a portion or the entire of the copper post of the third winding assembly 54 is penetrated through the second opening 518. Consequently, the second end of the copper post of the third winding assembly 54 is electrically connected with the output positive terminal Vo+ shown in FIG. 2.

In another embodiment, the third winding assembly 54 is implemented with a first copper post and a second copper post. The first end of the first copper post of the third winding assembly 54 is electrically connected with the second terminal of the third secondary winding NS21. The first end of the second copper post of the third winding assembly 54 is electrically connected with the second terminal of the fourth secondary winding NS22. In addition, a portion or the entire of the first copper post and a portion of the entire of the second copper post are penetrated through the second opening 518. The second end of the first copper post and the second end of the second copper post are directly connected with each other and electrically connected with the output positive terminal Vo+. Consequently, the first terminal of the third winding assembly 54 is electrically connected with the second secondary winding assembly.

Please refer to FIGS. 1A, 1B, 1C, 1D, 2, 3, 4 and 5 again. The circuit board 4 further includes a first connection hole 43 and a second connection hole 44. The first connection hole 43 and the second connection hole 44 run through the circuit board 4. When the upper magnetic cover 501 and the lower magnetic cover 511 of the magnetic core assembly 51 are respectively locked on the first surface 40 and the second surface 41 of the circuit board 4, the first magnetic leg 513 and the second magnetic leg 514 are respectively inserted in the first connection hole 43 and the second connection hole 44.

Please refer to FIGS. 1A, 1B, 1C and 1D again. Each of the first rectifying switch M11 and the second rectifying switch M12 shown in FIG. 2 includes a plurality of parallel-connected switches, and the parallel-connected switches of the first rectifying switch M11 and the second rectifying switch M12 are integrated into a first rectifying switch module M1. Similarly, each of the third rectifying switch M21 and the fourth rectifying switch M22 shown in FIG. 2 includes a plurality of parallel-connected switches, and the parallel-connected switches of the third rectifying switch M21 and the fourth rectifying switch M22 are integrated into a second rectifying switch module M2. The first rectifying switch module M1 and the second rectifying switch module M2 are installed on the first surface 40 of the circuit board 4. In addition, the first rectifying switch module M1 and the second rectifying switch module M2 are symmetrically located beside two opposite sides of the upper magnetic cover 510.

The first rectifying switch module M1 is located beside the third lateral wall 47 of the circuit board 4. The second rectifying switch module M2 is located beside the fourth lateral wall 48 of the circuit board 4. As shown in FIG. 1A, a third virtual line L3 passes through the center of the rectifying switch module M1 and the center of the second rectifying switch module M2. The third virtual line L3 is substantially perpendicular to the length direction of the upper magnetic cover 510. In addition, the upper magnetic cover 510 is evenly divided into two blocks by the third virtual line L3.

An angle between the projection line of the third virtual line L3 on the first surface 40 of the circuit board 4 and the projection line of the first virtual line L1 (see FIG. 5) on the first surface 40 of the circuit board 4 is greater than or equal to 0 degree and smaller than or equal to 45 degrees. For example, the angle between the projection line of the third virtual line L3 on the first surface 40 of the circuit board 4 and the projection line of the first virtual line L1 on the first surface 40 of the circuit board 4 is 0 degree. Similarly, an angle between the projection line of the third virtual line L3 on the first surface 40 of the circuit board 4 and the projection line of the second virtual line L2 (see FIG. 5) on the first surface 40 of the circuit board 4 is greater than or equal to 0 degree and smaller than or equal to 45 degrees. For example, the angle between the projection line of the third virtual line L3 on the first surface 40 of the circuit board 4 and the projection line of the second virtual line L2 on the first surface 40 of the circuit board 4 is 0 degree.

In an embodiment, the projection region of the first rectifying switch module M1 with respect to any reference plane (e.g., the first surface 40 of the circuit board 4) and the projection region of the lower magnetic cover 511 with respect to the reference plane are partially overlapped with each other. Similarly, the projection region of the second rectifying switch module M2 with respect to the reference plane and the projection region of the lower magnetic cover 511 with respect to the reference plane are partially overlapped with each other.

For reducing the wiring length, the drain terminal of the first rectifying switch M11 in the first rectifying switch module M1 is closer to the upper magnetic cover 510 than the source terminal of the first rectifying switch M11 in the first rectifying switch module M1. Similarly, the drain terminal of the second rectifying switch M12 in the first rectifying switch module M1 is closer to the upper magnetic cover 510 than the source terminal of the second rectifying switch M12 in the first rectifying switch module M1. Similarly, the drain terminal of the third rectifying switch M21 in the second rectifying switch module M2 is closer to the upper magnetic cover 510 than the source terminal of the third rectifying switch M21 in the second rectifying switch module M2. Similarly, the drain terminal of the fourth rectifying switch M22 in the second rectifying switch module M2 is closer to the upper magnetic cover 510 than the source terminal of the fourth rectifying switch M22 in the second rectifying switch module M2.

In an embodiment, each of the second winding assembly 53 and the third winding assembly 54 is implemented with at least one copper post. As shown in FIGS. 1B and 1D, the second winding assembly 53 includes a first copper post 530, and the third winding assembly 54 includes a second copper post 540.

The first copper post 530 is penetrated through the first opening 517. The first end of the first copper post 530 is electrically connected with the second terminal of the first secondary winding NS11 and the second terminal of the second secondary winding NS12 (i.e., the midpoint of the first secondary winding assembly) and welded on a first solder pad (not shown) on the second surface 41 of the circuit board 4. The second end of the first copper post 530 is exposed to the lower magnetic cover 511. In other words, the first copper post 530 is used as the winding of the first output inductor Lot and the conduction terminal of the output positive terminal Vo+.

The second copper post 540 is penetrated through the second opening 518. The first end of the second copper post 540 is electrically connected with the second terminal of the third secondary winding NS21 and the second terminal of the fourth secondary winding NS22 (i.e., the midpoint of the second secondary winding assembly) and welded on a second solder pad (not shown) on the second surface 41 of the circuit board 4. The second end of the second copper post 540 is exposed to the lower magnetic cover 511. In other words, the second copper post 540 is used as the winding of the second output inductor Lo2 and the conduction terminal of the output positive terminal Vo+.

In an embodiment, the size of the first copper post 530 matches the size of the first opening 517. Consequently, the first copper post 530 is in close contact with the inner surface of the first opening 517. Similarly, the size of the second copper post 540 matches the size of the second opening 518. Consequently, the second copper post 540 is in close contact with the inner surface of the second opening 518.

In an embodiment, the size of the first opening 517 is greater than the size of the first copper post 530. Consequently, a gap is formed between the first copper post 530 and the inner surface of the first opening 517. Similarly, the size of the second opening 518 is greater than the size of the second copper post 540. Consequently, a gap is formed between the second copper post 540 and the inner surface of the second opening 518.

Please refer to FIGS. 1A, 1C and 2 again. In an embodiment, each of the upper switch Q1 and the lower switch Q2 includes a plurality of parallel-connected switches, and the parallel-connected switches of the upper switch Q1 and the lower switch Q2 are integrated into a switching module Q12. The switching module Q12 is installed on the first surface 40 of the circuit board 4 and located beside the first opening 517. As shown in FIG. 1A, the switching module Q12 is located beside the fourth lateral wall 48 of the circuit board 4 and disposed between the second rectifying switch module M2 and the second lateral wall 46 of the circuit board 4. It is noted that the position of the switching element Q12 is not restricted. For example, in another embodiment, the switching element Q12 is located beside the third lateral wall 47 of the circuit board 4 and disposed between the first rectifying switch module M1 and the second lateral wall 46 of the circuit board 4.

Please refer to FIGS. 1B and 1D again. In an embodiment, the first capacitor C1 and the second capacitor C2 are installed on the second surface 41 of the circuit boar 4. In addition, the first capacitor C1 and the second capacitor C2 are located beside the fourth lateral wall 48 of the circuit board 4 and disposed between the lower magnetic cover 511 and the second lateral wall 46 of the circuit board 4. In addition, the positions of the first capacitor C1 and the second capacitor C2 on the second surface 41 of the circuit boar 4 are close to the position of the switching module Q12 on the first surface 40 of the circuit board 4. Consequently, the distance between the first capacitor C1 (or the second capacitor C2) and the switching module Q12 is as short as possible. The input capacitors Cin are installed on the first surface 40 or the second surface 41 of the circuit board 4. Please refer to FIGS. 1A, 1B and 2. Some of the plurality of input capacitors Cin are installed on the second surface 41 of the circuit board 4 and located beside the first capacitor C1 and the second capacitor C2. The other input capacitors Cin are installed on the first surface 41 of the circuit board 4 and located beside the switching module Q12.

The power conversion module 1 further includes four negative output pads 6. The four negative output pads 6 are installed on the second surface 41 of the circuit board 4. The four negative output pads 6 are respectively located beside four corners of the lower magnetic cover 511. The first negative output pad 6 is located beside the first corner of the lower magnetic cover 511 and located beside the first lateral wall 45 and the fourth lateral wall 48 of the circuit board 4. The second negative output pad 6 is located beside the second corner of the lower magnetic cover 511 and located beside the first lateral wall 45 and the third lateral wall 47 of the circuit board 4. The third negative output pad 6 is located beside the third corner of the lower magnetic cover 511 and located at a middle region of the fourth lateral wall 48 of the circuit board 4. The third negative output pad 6 is located beside the fourth corner of the lower magnetic cover 511 and located at a middle region of the third lateral wall 47 of the circuit board 4. In an embodiment, the negative output pads 6 are copper posts, which are served as output negative terminals Vo− shown in FIG. 2. The position of each of the negative output pads 6 on the second surface 41 of the circuit board 4 is specially designed. Consequently, the distance between the negative output pad 6 and the source terminal of the first rectifying switch module M1 or the source terminal of the second rectifying switch module M2 is the shortest.

The power conversion module 1 further includes a plurality of signal pads 7. As shown in FIG. 1B, the power conversion module 1 includes nine signal pads 7. The plurality of signal pads 7 are used to transmit control signals, detection signals or power signals. The plurality of signal pads 7 are installed on the second surface 41 of the circuit board 4 and located beside the second lateral wall 46 of the circuit board 4.

As shown in FIG. 4, each of the first secondary winding NS11, the second secondary winding NS12, the third secondary winding NS21 and the fourth secondary winding NS22 is wound for 0.5 turn. The first rectifying circuit 31 (i.e., the rectifying switches M11 and M12) and the first output inductor Lo1 are respectively located beside two opposite sides of the magnetic core assembly 51. The second rectifying circuit 32 (i.e., the rectifying switches M21 and M22) and the second output inductor Lo2 are respectively located beside two opposite sides of the magnetic core assembly 51.

A fourth virtual line (not shown) passes through the center of the first rectifying switch module M1 and the first output inductor Lo1. A fifth virtual line (not shown) passes through the center of the second rectifying switch module M2 and the second output inductor Lo2. An angle between the fourth virtual line and the fifth virtual line is greater than or equal to 0 degree and smaller than or equal to 45 degrees. In an embodiment, the angle between the fourth virtual line and the fifth virtual line is 0 degree.

In the above embodiments, all switches are MOSFET switches. It is noted that the types of the switches are not restricted. In some other embodiments, SiC switches or GaN switches are suitably used as the switches of the power conversion module. The relationships between the terminals of each switch and the associated component are designed according to the type of the switch.

From the above descriptions, the present disclosure provides a power conversion module. The magnetic core assembly of the magnetic device of the power conversion module are specially designed. The transformer and the inductor are integrated into the same magnetic device. Consequently, the voltage reduction function and the filtering function can be achieved. For example, the high input voltage (e.g., a 48V input voltage) is decreased to the low output voltage (e.g., 2.2V output voltage). Moreover, the volume of the power conversion module is effectively reduced, and the integration of the power conversion module is enhanced. Consequently, the power conversion module has the advantages of low output ripple, small volume, high efficiency and simplified applications. Moreover, due to the arrangement of the output inductors and the output capacitor, the volt-second product withstood by the output inductors is largely reduced. Moreover, the inductors with the smaller inductance can be used as the output inductors to suppress the current ripple. Consequently, the load dynamic response speed of the power conversion module is enhanced.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A magnetic device comprising a magnetic core assembly, the magnetic core assembly comprising:
an upper magnetic cover;
a lower magnetic cover aligned with the upper magnetic cover, and comprising a first opening and a second opening, wherein the first opening and the second opening run through the lower magnetic cover;
a first magnetic leg disposed between the upper magnetic cover and the lower magnetic cover;
a second magnetic leg disposed between the upper magnetic cover and the lower magnetic cover; and
a channel disposed between the first magnetic leg and the second magnetic leg,
wherein the first opening and the second opening are respectively located beside outer sides of the first magnetic leg and the second magnetic leg,
wherein when the upper magnetic cover and the lower magnetic cover are locked on a circuit board, the first magnetic leg and the second magnetic leg are included in a projection region of the upper magnetic cover with respect to the lower magnetic cover.

2. The magnetic device according to claim 1, wherein the magnetic device further comprises:
a first winding assembly comprising a first secondary winding and a second secondary winding, wherein the first secondary winding is wound around the first magnetic leg along a first direction and wound around the second magnetic leg along a second direction, and the second secondary winding is wound around the first magnetic leg along the second direction and wound around the second magnetic leg along the first direction, wherein the first direction and the second direction are opposite to each other; and
a second winding assembly penetrated through the first opening and electrically connected with the first secondary winding and the second secondary winding, wherein the second winding assembly is a portion of a first inductor.

3. The magnetic device according to claim 2, wherein each of the first secondary winding and the second secondary winding comprises a first terminal and a second terminal, wherein the second terminal of the first secondary winding and the second terminal of the second secondary winding are electrically connected with a first winding midpoint, a first terminal of the second winding assembly is electrically connected with the first winding midpoint, and a second terminal of the second winding assembly is penetrated through the first opening and exposed to the lower magnetic cover.

4. The magnetic device according to claim 3, wherein each of the first secondary winding and the second secondary winding is wound for 0.5 turn, the first terminal of the first secondary winding is located beside a first side of the magnetic core assembly, the second terminal of the first secondary winding is located beside a second side of the magnetic core assembly, and the channel is divided into a first part and a second part, wherein from the first terminal to the second terminal, the first secondary winding is sequentially transferred through the first side of the magnetic core assembly, the first part of the channel, the second part of the channel and the second side of the magnetic core assembly, wherein the first terminal of the second secondary winding is located beside the first side of the magnetic core assembly, and the second terminal of the second secondary winding is located beside the second side of the magnetic core assembly, wherein from the first terminal to the second terminal, the second secondary winding is sequentially transferred through the first side of the magnetic core assembly, the second part of the channel, the first part of the channel and the second side of the magnetic core assembly.

5. The magnetic device according to claim 4, wherein the first winding assembly comprising a third secondary winding and a fourth secondary winding, and the magnetic device further comprises a third winding assembly, wherein the third secondary winding is wound around the first magnetic leg along the second direction and wound around the second magnetic leg along the first direction, and the fourth secondary winding is wound around the second magnetic leg along the second direction and wound around the first magnetic leg along the first direction, wherein the third winding assembly is penetrated through the second opening and electrically connected with the third secondary winding and the fourth secondary winding, and the third winding assembly is a portion of a second inductor.

6. The magnetic device according to claim 5, wherein each of the third secondary winding and the fourth secondary winding comprises a first terminal and a second terminal, wherein the second terminal of the third secondary winding and the second terminal of the fourth secondary winding are electrically connected with a second winding midpoint, a first terminal of the third winding assembly is electrically connected with the second winding midpoint, and a second terminal of the third winding assembly is penetrated through the second opening and exposed to the lower magnetic cover.

7. The magnetic device according to claim 6, wherein each of the third secondary winding and the fourth secondary winding is wound for 0.5 turn, the first terminal of the third secondary winding is located beside the second side of the magnetic core assembly, and the second terminal of the third secondary winding is located beside the first side of the magnetic core assembly, wherein from the first terminal to the second terminal, the third secondary winding is sequentially transferred through the second side of the magnetic core assembly, the second part of the channel, the first part of the channel and the first side of the magnetic core assembly, wherein the first terminal of the fourth secondary winding is located beside the second side of the magnetic core assembly, and the second terminal of the fourth secondary winding is located beside the first side of the magnetic core assembly, wherein from the first terminal to the second terminal, the fourth secondary winding is sequentially transferred through the second side of the magnetic core assembly, the first part of the channel, the second part of the channel and the first side of the magnetic core assembly.

8. The magnetic device according to claim 2, wherein the first winding assembly further comprises a primary winding, wherein a first terminal and a second terminal of the primary winding are located beside the second side of the magnetic core assembly, and the channel is divided into a first part and a second part, wherein from the first terminal to the second terminal, the primary winding is sequentially transferred through the second side of the magnetic core assembly, the second part of the channel, the first part of the channel, the first side of the magnetic core assembly, the first part of the channel, the second part of the channel and the second side of the magnetic core assembly.

9. The magnetic device according to claim 6, wherein a first virtual line passes through a center of the first magnetic leg and a center of the second magnetic leg, a second virtual line passes through a center of the first opening and a center of the second opening, and an angle θ between the first virtual line and the second virtual line is larger than or equal to 0 degree and smaller than or equal to 45 degrees.

10. The magnetic device according to claim 9, wherein a distance between an inner surface of the first opening and a neighboring edge of the lower magnetic cover along the second virtual line and a distance between an inner surface of the second opening and a neighboring edge of the lower magnetic cover along the second virtual line are equal.

11. The magnetic device according to claim 5, wherein the first terminal of the first secondary winding and the first terminal of the second secondary winding are electrically connected with a first rectifying switch module of a power conversion module, and the first terminal of the third secondary winding and the first terminal of the fourth secondary winding are electrically connected with a second rectifying switch module of the power conversion module, wherein the first rectifying switch module and the second rectifying switch module are symmetrically located beside the first side and the second side of the upper magnetic cover.

12. The magnetic device according to claim 11, wherein the first rectifying switch module comprises a first rectifying switch and a second rectifying switch, and the second rectifying switch module comprises a third rectifying switch and a fourth rectifying switch, wherein the first terminal of the first secondary winding is electrically connected with a drain terminal of the first rectifying switch, the first terminal of the second secondary winding is electrically connected with a drain terminal of the second rectifying switch, and a source terminal of the first rectifying switch and a source terminal of the second rectifying switch are connected with each other and electrically connected with an output negative terminal of the power conversion module, wherein a drain terminal of the third rectifying switch is electrically connected with the first terminal of the third secondary winding, a drain terminal of the fourth rectifying switch is electrically connected with the first terminal of the fourth secondary winding, and a source terminal of the third rectifying switch and a source terminal of the fourth rectifying switch are connected with each other and electrically connected with the output negative terminal of the power conversion module.

13. The magnetic device according to claim 12, wherein the first rectifying switch and the third rectifying switch are disposed along a first diagonal line, and the second rectifying switch and the fourth rectifying switch are disposed along a second diagonal line, and the first diagonal line and the second diagonal line intersect each other, wherein a phase of a driving signal for driving the first rectifying switch and a phase of a driving signal for driving the third rectifying switch are identical, and a phase of a driving signal for driving the second rectifying switch and a phase of a driving signal for driving the fourth rectifying switch are identical.

14. The magnetic device according to claim 9, wherein the first terminal of the first secondary winding and the first terminal of the second secondary winding are electrically connected with a first rectifying switch module of a power conversion module, and the first terminal of the third secondary winding and the first terminal of the fourth secondary winding are electrically connected with a second rectifying switch module of the power conversion module, wherein a third virtual line passes through a center of the rectifying switch module and a center of the second rectifying switch module, and an angle between the third virtual line and the first virtual line is larger than or equal to 0 degree and smaller than or equal to 45 degrees.

15. The magnetic device according to claim 11, wherein a projection region of the first rectifying switch module with respect to a reference plane and a projection region of the lower magnetic cover with respect to the reference plane are partially overlapped with each other, and a projection region of the second rectifying switch module with respect to the reference plane and the projection region of the lower magnetic cover with respect to the reference plane are partially overlapped with each other.

16. The magnetic device according to claim 6, wherein the first terminal of the second winding assembly and the first terminal of the third winding assembly are welded on a circuit board of a power conversion module, and the second terminal of the second winding assembly and the second terminal of the third winding assembly are used as conduction terminals of an output positive terminal of the power conversion module.

17. The magnetic device according to claim 1, wherein an area of the upper magnetic cover is smaller than or equal to 80% of an area of the lower magnetic cover; or
at least partial projection region of the upper magnetic cover with respect to a reference plane is included in a projection region of the lower magnetic cover with respect to the reference plane.

18. The magnetic device according to claim 1, wherein each of the upper magnetic cover, the first magnetic leg and the second magnetic leg is made of a high magnetic permeability material, and the lower magnetic cover is made of a low magnetic permeability material.

19. The magnetic device according to claim 1, wherein the magnetic device is included in a power conversion module, and the power conversion module comprises a plurality of conduction terminals, wherein the plurality of conduction terminals are located beside the lower magnetic cover, and used as an output negative terminal of the power conversion module.

20. A power conversion module, comprising:
a circuit board comprising a first surface, a second surface, a first connection hole and a second connection hole, wherein the first surface and the second surface are opposed to each other, and the first connection hole and the second connection hole run through the circuit board; and
a magnetic device comprising a magnetic core assembly, wherein the magnetic core assembly comprises an upper magnetic cover, a lower magnetic cover, a first magnetic leg, a second magnetic leg and a channel, wherein the lower magnetic cover is aligned with the upper magnetic cover, the lower magnetic cover comprises a first opening and a second opening, the first opening and the second opening run through the lower magnetic cover, the first opening and the second opening are respectively located beside outer sides of the first magnetic leg and the second magnetic leg, the first magnetic leg is disposed between the upper magnetic cover and the lower magnetic cover, the second magnetic leg is disposed between the upper magnetic cover and the lower magnetic cover, and the channel is disposed between the first magnetic leg and the second magnetic leg, wherein when the upper magnetic cover and the lower magnetic cover are locked on the circuit board, the first magnetic leg and the second magnetic leg are included in a projection region of the upper magnetic cover with respect to the lower magnetic cover,
wherein the upper magnetic cover is installed on the first surface of the circuit board, the lower magnetic cover is installed on the second surface of the circuit board, the first magnetic leg is inserted in the first connection hole, and the second magnetic leg is inserted in the second connection hole.
